(19) United States
(12) Patent Application Publication
(10) Pub. No.: US 2003/0187891 A1
(43) Pub. Date: Oct. 2, 2003

(54) Scaling method by using dual point slope control (DPSC)

(76) Inventor: Kun-Nan Cheng, Hsinchu (TW)

Correspondence Address: J.C. Patents, Inc., Suite 250, 4 Venture, Irvine, CA, 92618, US

(21) Appl. No.: 10/364,604

(22) Filed: Feb. 10, 2003

Related U.S. Application Data
(63) Continuation of application No. 60/369,526, filed on Apr. 1, 2002.

(51) Int. Cl. G06F 7/38

(52) U.S. Cl. 708/290

(57) ABSTRACT

A method for scaling a source data to a destination data, wherein two reference points of the source data denoted as 0 and 1 by quantities f(0) and f(1) are used. The quantity f(x) is used to describe the destination data with a range of 0≦x<1, and f(x) is a quadratic form with three coefficients a, b, c for f(x)=ax²+bx+c. The method comprises setting a slope factor D=[f(1)−f(0)] and a gain factor G, wherein a product DG is a slope assigned to a selected one of f′(0) and f′(1), in which G is used to adjust the slope. A constraint is applied on f(x) of quantities of f(0) and f(1) passing through the points of 0 and 1, and satisfying the slope. The coefficients of a, b, and c for f(x) are within the range of 0≦x<1, so that f(x) is used to scale the destination data.

### CROSS-REFERENCE TO RELATED APPLICATION

This application claims the priority benefit of U.S. provisional application titled “DUAL POINTS SLOP CONTROL (DPSC) SCALING” filed on Apr. 1, 2002, Serial No. 60/369,526. All disclosures of this application is incorporated herein by reference.

### BACKGROUND OF THE INVENTION

1. Field of the Invention

The present invention relates to a method of data scaling, and more particularly to a method of scaling up or down different types of data, such as graphics, image, video or audio data, and for the application of polygon curve fitting to many areas such as object moving tracking analysis, data analysis, and a finder for objects of 2D shape or 3D surface in graphic areas.

2. Description of Related Art

Scaling is useful for operations involving graphics, images, and video or audio applications, for expanding or shrinking sample resolution and for zooming. Especially in digital display devices with fixed resolution, different kinds of source image formats must be scaled to fit the required resolution of the digital display.

For example, a display panel may have a resolution of 1024×768 pixels in XGA mode, but the source image may be provided from a computer, video decoder, or other device that may have input resolution different from the display panel depending on the input mode. The input source in VGA mode (640×480 pixels) with resolution less that of display mode XGA needs to be scaled up when displayed on the XGA panel. On the other hand, an input source in SXGA mode (1280×1024 pixels) with resolution greater than that of display mode XGA needs to be scaled down when displayed on the XGA panel. Image resizing is very important for digital display devices such as LCD. Various well-known conventional methods, such as Bilinear, Cubic, B-Spline, Bésier have been proposed in order to achieve a good filtering effect for scaling uses.

The Bilinear method is the most commonly used method using interpolation. Its advantages are its simplicity, speed, and cost since only two reference points are taken. As a result, the cost of the implementation of the Bilinear method is low because computation and storage requirements are less compared with other high-order interpolation methods. However, the output of the Bilinear method is blurry due to lack of sharpness from the interpolation results and is, therefore, not suitable for use in text images. The sharpness of the picture quality depends on the curve after fitting the interpolation points. The Bilinear method takes the weighting average as the interpolation result. When considering two neighboring pixels A, B, if the interpolation point C is located between A and B with distance D(D≦1) from A, then the interpolation result, according to the Bilinear method, is

C=A(1−D)+BD Eq. 1

In this manner, even though the interpolation form is simple, the quality is poor.

Cubic or B-Spline methods are the more preferred methods used in high quality scaling system with almost perfect scaling quality, but the cost is very high for computation and storage. Cubic methods usually require 4 points ƒ(−1l), ƒ(0), ƒ(1), and ƒ(2) as reference. The Cubic Curve using the Hermite Method has one start point P₁, one end point P₂, one start point tangent-vector R₁, and one end point tangent-vector R₂ by the formula

$$\begin{matrix}\begin{matrix}f ( x ) = ( 2 {x}^{3} - 3 {x}^{2} + 1 ) {P}_{1} + ( - 2 {x}^{3} + 3 {x}^{2} ) {P}_{2} + \\ ( {x}^{3} - 2 {x}^{2} + x ) {R}_{1} + ( {x}^{3} - {x}^{2} ) {R}_{2}\end{matrix} & Eq . 2 \\ \begin{matrix} & = ( 2 {P}_{1} - 2 {P}_{2} + {R}_{1} + {R}_{2} ) {x}^{3} + \\ & ( - 3 {P}_{1} + 3 {P}_{2} - 2 {R}_{1} - {R}_{2} ) {x}^{2} + {R}_{1} x + {P}_{1}\end{matrix} & Eq . 3\end{matrix}$$

where

P₁=ƒ(0),

P₂=ƒ(1)

R₁=G₁(P₂−P₀)/2=G₁[ƒ(1)−ƒ(−1)]/2=tangent-vector at P1

R₂=G₂(P₃−P₁)/2=G₂[ƒ(2)−ƒ(0)]/2=tangent-vector at P₂

G₁, G₂ are gain factors, wherein gain factor is proportional to the sharpness of the scaling result.

Of the foregoing conventional methods, the Bilinear method can be easily implemented. However, the interpolation result depends on values of only two points, and when the change of value at certain ranging has a large variation, the image after scaling would lose fidelity. For the Cubic or B-Spline methods, more information is included, but its implementation is more complex, the cost is high and the computation is more tedious. So, the foregoing conventional methods have their disadvantages.

### SUMMARY OF THE INVENTION

The DPSC method of the present invention requires only two reference points so that computation and storage requirements are less than that of Cubic or B-Spline methods and equal to the minimal size of the Bilinear method. Each piece of destination data can be generated with only two source points as reference. A slope control is used to control the sharpness of the interpolation result. The interpolation curve starts from one of the two neighboring source points with a slope S, defined at both the source points in the direction in which the curve is moving. Different start point slope gain DG affects the scaling quality, and can be adjusted according to the different scaling requirements.

A method is provided in the present invention for scaling a source data to a destination data, wherein two reference points of the source data, denoted as 0 and 1 by quantities of f(0) and f(1) are used. The symbol f(x) is used to describe the destination data with a range of 0≦x<1, and f(x) is a quadratic form with three coefficients a, b, c for f(x)=ax²+bx+c. The method comprises setting a slope factor D=[f(1)−f(0)] and a gain factor G, wherein a product by DG is a slope assigned to a selected one of the f′(0) and f′(1), in which G is used to adjust the slope. A constraint is applied on f(x) by passing through the points of 0 and 1 by quantities of f(0) and f(1), and satisfying the slope. The coefficients of a, b, and c for f(x) are within the range of 0≦x<1, so that f(x) is used to scale the destination data.

Another method is provided in the invention for scaling a source data to a destination data, wherein two reference points of the source data denoted as 0 and 1 by quantities of f(0) and f(1) are used, in which f(x) is used to describe the destination data with a range of 0=x<1. The method comprises setting a slope factor D=[f(1)−f(0)] and a gain factor G, wherein a product by DG is a slope assigned to a selected one of f′(0) and f′(1), in which G is used to adjust the slope. The source data is scaled based on the selected one f(x) from

f(x)=(ƒ(1)−ƒ(0)−DG)x²+DGx+ƒ(0) with respect of f′(0) and

f(x)=(ƒ(0)+DG−ƒ(1)x²+(2f(1)−2f(1)−2f(0)−DG)x+ƒ(0) with respect to f′(1).

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram illustrating the curve using the DPSC scaling method of present invention;

FIG. 2 is a schematic diagram illustrating the behavior using the DPSC scaling method with different gain of slope at the start source point;

FIG. 3 is a schematic diagram illustrating the result of scaling with a scaling factor of 0.75; and

FIG. 4 is a schematic diagram illustrating the application of the DPSC method on a 2D object shape of the present invention.

### DETAILED DESCRIPTION OF THE PREFERRED EMBODIMENTS

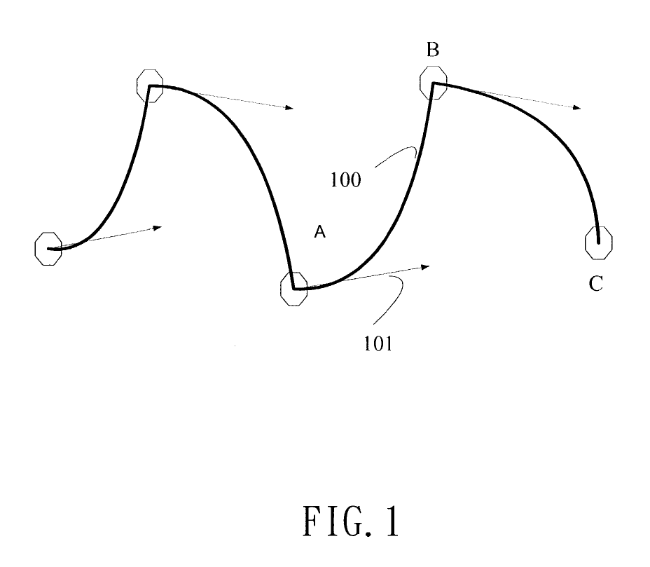

FIG. 1 shows the curve of DPSC scaling method of the present invention. The curve 100 ƒ(x) is a fitting curve using the DPSC method of the present invention. The reference number 101 indicates the slope at the point A, where points A, B, and C are the source points of curve 100. For any curve ƒ(x), the theory used in the present invention is as follows:

For a given function

ƒ(x)=ax²+bx+c Eq. 4

the first derivative equation is

ƒ′(x)=2ax+b, Eq. 5

wherein ƒ(0) and f(1) are defined as the two source reference points of the curve ƒ(x) being currently considered. Some parameters are defined as follows:

D is the slope factor of the start point, D=[ƒ(1)−ƒ(0)],

G is the gain factor, which preferably is G≧0.

A slope is a product of D and G by DG. Therefore,

ƒ′(0)=b=DG, Eq.6

ƒ(0)=c, Eq.7

ƒ(1)=a+b+c. Eq.8

The solution of the coefficients a, b, and for ƒ(x) with a current range denoted by 0≦x<1 is

ƒ(x)=(ƒ1)−ƒ(0)−DG)x²+DGx+ƒ(0) Eq. 9

The equation in Eq. 9 is not the only choice with respect to the initial condition as set in Eq. 6. When the end point at 1 with respect to f(l) is chosen, Eq. 6 can be replaced by

ƒ(1)=2a+b=DG, Eq.6a.

Using the other three related equations of Eq. 6a, Eq. 7 and Eq. 8 to solve for coefficients a, b, and c, a solution is obtained by

ƒ(x)=[ƒ(0)+DG−ƒ(1)x²+[2ƒ(1)−2ƒ(0)−DG]x+ƒ(0). Eq. 9a

However, the f(x) in Eq. 9 is preferred because of its simplicity.

The advantages of the DPSC method are low-cost, simplicity, and little quality loss compared with other high-order (3'rd or more) interpolation methods. It uses only two samples of reference points ƒ(0) and ƒ(1) but gets the scaling result sharper than the Bilinear method. It is especially useful in the case when finite storage is used. For example, in many applications, the vertical scaling operation must store the source image sample data in the line buffer. Two samples for the DPSC method require only two line buffers for zooming or shrinking. The gain factor G may affect the quality and preferably the ranges of G=0, 1>G>0, and 4>G>1 are good for scaling purposes, where G ≠1.

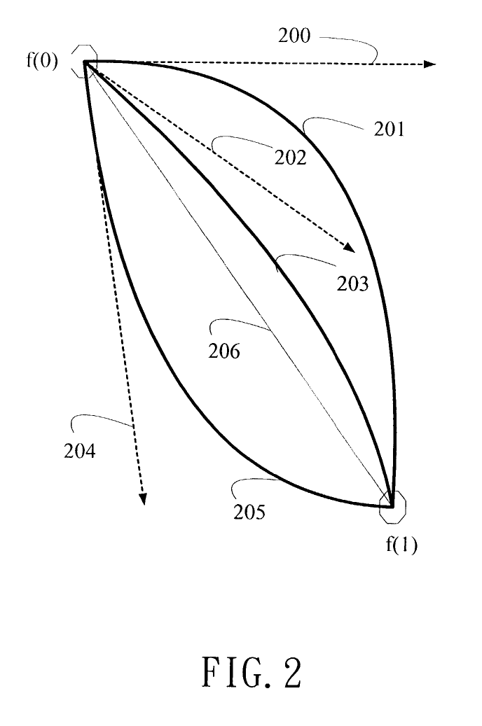

FIG. 2 shows the behavior of DPSC scaling of the present invention with different gain of slope at the start source point. The curve 201 has the slope 200 at point ƒ(0) according to the DPSC method, the curve 203 has the slope 202 at point ƒ(0) according to the DPSC method, and the curve 205 has the slope 204 at point ƒ(0) according to the DPSC method. The gain factor G of slope 200 is set to be equal to 0, the gain factor G of slope 202 is set to be smaller than 1, and the gain factor G of slope 204 is set to be greater than 1. It can be seen in FIG. 2 that these curves, which connect two points together, are visually different, forming a leaf shape. The difference in their curvature and the angle of curves 201, 203, and 205 is adjustable by the gain factor G. The gain factor G should be >0, and ≠1, wherein the slope is DG=[ƒ(1)−ƒ(0)]G, for 0≦x<1.

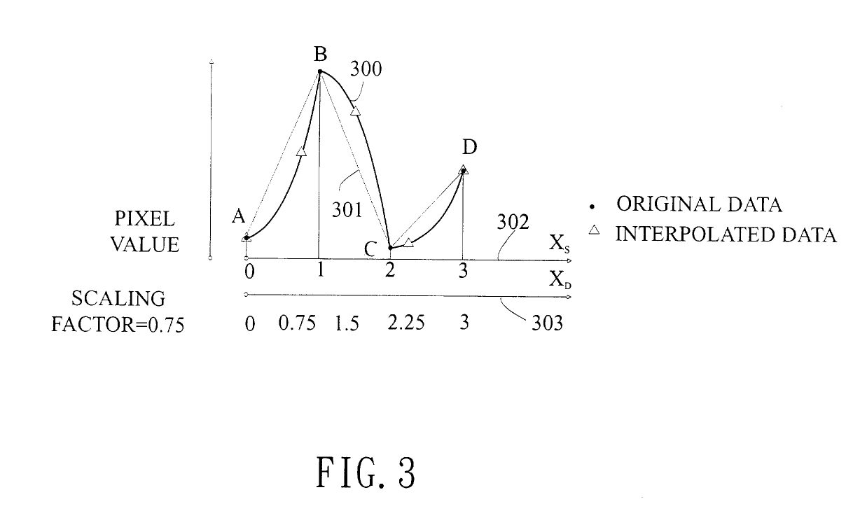

FIG. 3 shows an implementation according the DPSC method of the present invention. Curve 300 is the result according to the DPSC method and curve 301 is the result according to the Bilinear method for comparison. X_{S}302 is the source data location and X_{D}303 is the destination interpolation data location. For zooming and shrinking operations, the procedure is described below. Xₛ denotes the position coordinate with original data D₀, D₁, D₂, D₃, . . . , D_{M} where x=0, 1, 2, 3, . . . M.

A scaling factor generator generates the interpolation location X_{D}. The scaling factor is the ratio of the input resolution to the output resolution, and in the preferred embodiment the scaling factor is 0.75. A scaling factor <1 denotes up scaling and a scaling factor >1 denotes down scaling. The interpolation points x are between the coordinates x=N to x=N+1 for

ƒ(0)=D_{N}, and

ƒ(+1)=D_{N+1},

where x=0 . . . 1 (truncate the integer part N).

Applying DG, G≧0, G≧1, then

DG=[ƒ(1)−ƒ(0)]G,

with respect to

ƒ(x)=(ƒ(1)−(0)−DG)x²+(DG)x+ƒ(0)

for the location x=0 . . . 1, wherein ƒ(x) denotes the data after scaling or shrinking at point x.

The DPSC method is good for zooming and shrinking of graphics, images, video or audio, but also suitable for applications of polygon curve fitting such as object moving tracking analysis, data analysis, and a finder for objects of 2D shapes or 3D surface in graphic areas.

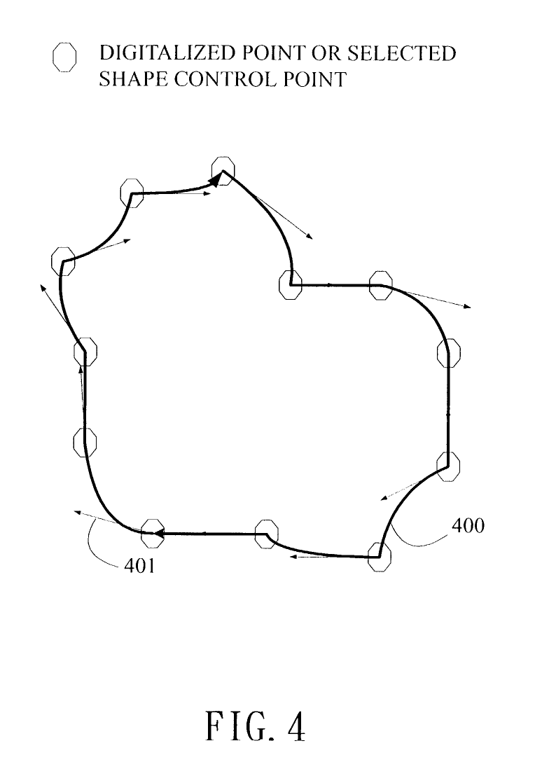

FIG. 4 shows the 2D object shape application using a single slope DPSC curve of the present invention as a finder. The curve 400 is the boundary shape of given source sample points using the DPSC method, and the curve 401 is the start point slope DG. By using the sample point or selected shape control point, and using the DPSC method, the curve 400 can be found, and it can represent the boundary of an object surrounded by sample points.

The DPSC scaling method of the present invention is low cost and has high scaling performance compared with the conventional methods of Cubic or B-Spline method. With the information of the start point slope and gain DG, the scaling quality can be controlled. The computing power may slightly greater than that of Bilinear method, but a sharper image can be had in scaling up when compared with the blur effect of Bilinear. Also, since only two reference points are required, less storage and computing power are needed compared with the Cubic or B-Spline method. It is very important when in vertical scaling, that the whole line must be stored in the line buffer. The more the reference points, the more line buffers are required. The present invention is excellent for use in many fields such as scaling of graphic, image, video, audio, or polygon curve fitting applications, moving tracking analysis, data analysis, or a finder for objects of 2D shape or 3D surface in graphic areas. It may be apparent to one skilled in the relevant arts how to implement several other embodiments and methods without departing from the scope and sprit of the present invention by reading the description provide above.

The scaling method can also be implemented into a circuit. The scaling circuit may, for example, include an initial circuit part, for setting the slope factor D=[ƒ(1)−ƒf(0)] and the gain factor G, wherein a product by DG is a slope assigned to f(x). A scaling circuit is used for scaling the input data into the output data within the range of 0≦x<1, based on a selected one of ƒ(x)=(ƒ(1)−ƒ(0)−DG)x²+DGx+ƒ(0) and f(x)=(ƒ(0)+DG−ƒ(1)x²+(2f(1)−2f(0)−DG)x+ƒ(0). After the current range has been scaled, the procedure can be repeated for the next range until the destination data has been completely accomplished.

Likewise, the method of the invention can also be implemented into a system. The system includes, for example, an initial unit, for setting a slope factor D=[f(1)−f(0)] and a gain factor G, wherein a product of DG is the slope assigned to f(x), in which G is used to adjust the slope. A scaling unit is used for scaling the input data into the output data within the range of 0≦x<1, based on a selected one of

f(x)=(ƒ(1)−ƒ(0)−DG)x²+DGx+ƒ(0) and

f(x)=(ƒ(0)+DG−ƒ(1))x²+(2f(1)−2f(0)−DG)x+ƒ(0).

After the current range has been scaled, the procedure can be repeated for the next range until the destination data has been completely accomplished.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for scaling a source data to a destination data, wherein two reference points of the source data denoted as 0 and 1 by quantities of f(0) and f(1) are used, in which f(x) is used to describe the destination data with a range of 0≦x<1, and f(x) is a quadratic form with three coefficients a, b, c for f(x)=ax²+bx+c, the method comprising:
setting a slope factor D=[f(1)−f(0)] and a gain factor G, wherein a product DG is a slope assigned to a selected one of the f′(0) and f′(1), in which G is used to adjust the slope;
applying a constraint on f(x) of quantities f(0) and f(1) passing through the points of 0 and 1, and satisfying the slope;
solving the coefficients of a, b, and c for f(x) within the range of 0≦x<1, so that f(x) is used to scale the destination data.

2. The method of claim 1, wherein, if the slope DG is assigned to f′(0), three related equations are set as follows:
ƒ′(0)=b=DG,
ƒ(0)c, and
ƒ(1)=a+b+c,
so as to obtain the f(x)=(ƒ(1)−ƒ(0)−DG)x²+DGx+ƒ(0).

3. The method of claim 2, wherein G greater than or equal to 0.

4. The method of claim 1, wherein, if the slope DG is assigned to f′(1), three related equations are set as follows:
ƒ′(1)=2a+b=DG,
ƒ(0)=c, and
ƒ(1)=a+b+c,
so as to obtain f(x)=(ƒ(0)+DG −ƒ(1))x²+(2f(1)−2f(0)−DG)x+ƒ(0).

5. The method of claim 4, wherein G greater than or equal to 0.

6. The method of claim 1, wherein after the destination data belonging to the current range is accomplished, next two reference points of the source data are continuously scaled until the destination data are completely accomplished.

7. A scaling circuit, used to scale input data and export output data, wherein the circuit employs a curve function f(x) to describe the output data, wherein f(x) is determined by choosing two reference points of the source data denoted as 0 and 1 by quantities of f(0) and f(1) for use, wherein f(x) is used to describe the output data with a range of 0≦x<1, and f(x) is a quadratic form with three coefficients a, b, c for f(x)=ax²+bx+c, the circuit comprising:
an initial circuit part, for setting a slope factor D=[f(1)−f(0)] and a gain factor G, wherein a product DG is the slope assigned to f(x), in which G is used to adjust the slope; and
a scaling circuit for scaling the input data into the output data within the range of 0≦x<1, based on a selected one of
f(x)=(ƒ(1)−ƒ(0)−DG)x²+DGx+ƒ(0)+ƒ(0) and
f(x)=(ƒ(0)+DG−ƒ(1))x²+(2f(1)−2f)(0)−DG)x+ƒ(0).

8. The scaling circuit of claim 7, wherein when the slope DG is assigned to the point 0 associated with f′(0), f(x) is (ƒ(1)−(0)−DG)x²+DGx+ƒ(0).

9. The scaling circuit of claim 7, wherein when the slope DG is assigned to the point 0 associated with f′(1), f(x) is (ƒ(0)+DG −ƒ(1))x²+(2f(1) −2f(0)−DG)x+ƒ(0).

10. A method for generating destination data samples f(x) in response to two source data samples f(0) and f(1), wherein f(x) is generated for x in a range of 0≦x<1, said method comprising the steps of:
(a) fitting a quadratic equation of f(x)=ax²+bx+c to said source data samples f(0) and f(1); and
(b) generating a resulting equation f(x)=(ƒ(1)−ƒ(0)−DG)x²+DGx+ƒ(0) for the region of 0≦x<1, wherein DG designates a slope at said source data sample f(0).

11. A method for generating destination data samples f(x) in response to two source data samples f(0) and f(1), wherein f(x) is generated for x in a range of 0≦x<1, said method comprising the steps of:
(a) fitting a quadratic equation of f(x)=ax²+bx+c to said source data samples f(0) and f(1); and
(b) generating a resulting equation f(x)=(ƒ(0)+DG −ƒ(1)x²+(2f(1)−2f(0)−DG) x+ƒ(0) for the region of 0≦x<1, wherein DG designates a slope at said source data sample f(1).
